(19) United States
(12) Patent Application Publication
(10) Pub. No.: US 2014/0052819 A1
(43) Pub. Date: Feb. 20, 2014

(54) HTTP-BASED CONTENT ACQUISITION METHOD AND CLIENT

(71) Applicant: HUAWEI DEVICE CO., LTD., Shenzhen (CN)

(72) Inventor: Haoran ZHANG, Shanghai (CN)

(73) Assignee: HUAWEI DEVICE CO., LTD., Shenzhen (CN)

(21) Appl. No.: 14/061,986

(22) Filed: Oct. 24, 2013

Related U.S. Application Data
(63) Continuation of application No. PCT/CN2011/073455, filed on Apr. 28, 2011.

(51) Int. Cl. H04L 29/08

(52) U.S. Cl. CPC H04L 67/02
USPC 709/217

(57) ABSTRACT

Embodiments of the present invention provide an HTTP-based content acquisition method and client. The method includes: acquiring, by a client according to an acquired content identifier, a first content corresponding to the content identifier and a validity period of the first content from a cache; displaying, by the client, the first content; requesting, by the client according to the validity period of the first content, a server to verify validity of the first content; requesting, by the client, to acquire a second content corresponding to the content identifier from the server if the validity verification performed by the server for the first content fails; and displaying, by the client, the second content. In this way, the delay in displaying the content on the client can be reduced, thereby improving the display efficiency of the client.

### CROSS-REFERENCE TO RELATED APPLICATIONS

This application is a continuation of International Application No. PCT/CN2011/073455, filed on Apr. 28, 2011, which is hereby incorporated by reference in its entirety.

### TECHNICAL FIELD

Embodiments of the present invention relate to communication technologies, and in particular, to a HyperText Transfer Protocol (HyperText Transfer Protocol, HTTP for short)-based content acquisition method and client.

### BACKGROUND

Before a client on a terminal requests, through a HyperText Transfer Protocol (HyperText Transfer Protocol, HTTP for short), to acquire a content from a server, the client may first check whether the requested content exists in a cache. If the content exists in the cache, the client acquires the content and a validity period of the content from the cache first. If the client determines that the content is valid according to the validity period of the content, the client may display the content directly; if the client determines that the content is invalid according to the validity period of the content, the client requests a server to verify validity of the content; if the validity verification performed by the server for the content fails, the client requests to acquire a corresponding new content from the server; if the validity verification performed by the server for the content succeeds, the server returns confirmation information to the client so that the client displays the content directly.

When the server verifies a content that continues to be valid, the verification causes a delay in displaying the content on the client, and therefore reduces the display efficiency of the client.

### SUMMARY

Embodiments of the present invention provide an HTTP-based content acquisition method and client to improve display efficiency of a client.

An embodiment of the present invention provides an HTTP-based content acquisition method, including:
acquiring, by a client according to an acquired content identifier, a first content corresponding to the content identifier and a validity period of the first content from a cache;
displaying, by the client, the first content;
requesting, by the client according to the validity period of the first content, a server to verify validity of the first content;
requesting, by the client, to acquire a second content corresponding to the content identifier from the server if the validity verification performed by the server for the first content fails; and
displaying, by the client, the second content.

An embodiment of the present invention provides another HTTP-based content acquisition method, including:
acquiring, by a client, a fourth content;
displaying, by the client, the fourth content; and
acquiring, by the client according to a content identifier included in the fourth content, a fifth content corresponding to the content identifier after a preset time interval.

An embodiment of the present invention further provides a client, including:
a first acquiring module, configured to acquire, according to an acquired content identifier, a first content corresponding to the content identifier and a validity period of the first content from a cache;
a first displaying module, configured to display the first content;
a verification requesting module, configured to request, according to the validity period of the first content, a server to verify validity of the first content;
a second acquiring module, configured to request to acquire a second content corresponding to the content identifier from the server if the validity verification performed by the server for the first content fails; and
a second displaying module, configured to display the second content.

An embodiment of the present invention further provides another client, including:
a first acquiring module, configured to acquire a first content;
a content displaying module, configured to display the first content; and
a second acquiring module, configured to acquire, according to a content identifier included in the first content, a second content corresponding to the content identifier after a preset time interval.

As may be known from the above technical solutions, the embodiments of the present invention can reduce the delay in displaying the content on the client, and therefore improve the display efficiency of the client.

### BRIEF DESCRIPTION OF DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and persons of ordinary skill in the art may still derive other drawings from these accompanying drawings without creative efforts.

FIG. 1 is a schematic flowchart of an HTTP-based content acquisition method according to an embodiment of the present invention;

FIG. 2 is a schematic flowchart of another HTTP-based content acquisition method according to another embodiment of the present invention;

FIG. 3 is a schematic structural diagram of a client according to another embodiment of the present invention; and

FIG. 4 is a schematic structural diagram of another client according to another embodiment of the present invention.

### DESCRIPTION OF EMBODIMENTS

To make the aspects, technical solutions, and advantages of the embodiments of the present invention more comprehensible, the following clearly describes the technical solutions in the embodiments of the present invention with reference to the accompanying drawings in the embodiments of the present invention. Apparently, the described embodiments are merely a part rather than all of the embodiments of the present invention. All other embodiments obtained by persons of ordinary skill in the art based on the embodiments of the present invention without creative efforts shall fall within the protection scope of the present invention.

It should be noted that terminals involved in the embodiments of the present invention include but are not limited to a mobile phone, a personal digital assistant (Personal Digital Assistant, PDA for short), a wireless handheld device, a wireless netbook, a portable computer, an MP3 player, an MP4 player, and so on.

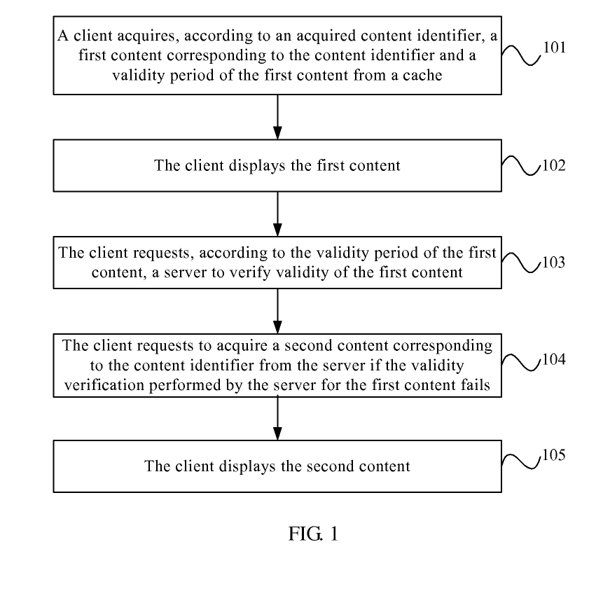

FIG. 1 is a schematic flowchart of an HTTP-based content acquisition method according to an embodiment of the present invention. As shown in FIG. 1, the HTTP-based content acquisition method in this embodiment may include the following steps:

Step 101: A client acquires, according to an acquired content identifier, a first content corresponding to the content identifier and a validity period of the first content from a cache.

The content identifier is acquired by the client from content-related information input by a user through an input device. For example, the user inputs a web address through a keyboard, and therefore, the client acquires the web address as a content identifier; for another example, the user clicks a web page name in favorites through a mouse, and therefore, the client acquires the web address corresponding to the web page name as a content identifier.

Specifically, the client may acquire, according to the acquired content identifier, the first content corresponding to the content identifier and a validity period identifier of the first content from the cache, and therefore, may acquire, according to the validity period identifier of the first content, a validity period corresponding to the validity period identifier of the first content; or, the client may acquire, according to the acquired content identifier, the first content corresponding to the content identifier but no validity period identifier of the first content from the cache, and therefore, may use a preset validity period, for example, 0, as the validity period of the first content.

Step 102: The client displays the first content.

Specifically, the client may display the first content according to characteristic information of the first content. The characteristic information of the first content may include but is not limited to the type of the content and keywords of the content. For example, if the characteristic information of the first content is a content type such as image and fiction, the client may display the first content; if the characteristic information of the first content is a content type such as news and forum, the client may give up displaying the first content; if the characteristic information of the first content is a content keyword such as registration and verification code, the client may give up displaying the first content.

Step 103: The client requests, according to the validity period of the first content, a server to verify validity of the first content.

Specifically, if the duration of caching the first content on the client exceeds the validity period, the client may request the server to verify validity of the first content.

Understandably, if the client determines that the content is valid according to the validity period of the first content, the client does not need to request the server to verify validity of the first content.

Step 104: The client requests to acquire a second content corresponding to the content identifier from the server if the validity verification performed by the server for the first content fails.

Understandably, although the validity verification performed by the server for the first content fails, it is still possible that the second content requested and acquired by the client is exactly the same as the first content.

Step 105: The client displays the second content.

Specifically, if the second content is exactly the same as the first content, the client may give up displaying the second content (but continue displaying the first content), or may further display the second content; if the second content is different from the first content, the client may display the second content.

It should be noted that if the validity verification performed by the server for the first content succeeds, the client continues displaying the first content, and the process of this embodiment ends immediately; if the validity verification performed by the server for the first content fails, the client continues to perform steps 104 and 105 before the process of this embodiment ends.

In this embodiment, step 102 and step 103 are in no particular order, and this embodiment does not limit the implementation order.

In this embodiment, after acquiring the content identifier, the client displays the first content directly no matter whether the first content corresponding to the content identifier in the cache is valid. Moreover, while the first content is displayed, the cache is verified; if the cache is valid, no step needs to be performed, and the first content is still displayed. If the cache needs to be verified by a network-side server, the server may be requested to perform verification: If the cache is valid, no step needs to be performed, and the first content is still displayed; if the cache has expired, a second content (the updated first content) is re-acquired from the server.

In this embodiment, through a client acquires, according to an acquired content identifier, a first content corresponding to the content identifier and a validity period of the first content from a cache, and displays the first content. Meanwhile, according to the validity period of the first content, the client requests a server to verify validity of the first content. If the validity verification performed by the server for the first content succeeds, the client may continue displaying the current first content, thereby avoiding the problem that the client does not display the content until the validity verification performed by the server for the content in the cache succeeds in the prior art, reducing the delay in displaying the content on the client, and improving display efficiency of the client.

After step 102, the client may further re-acquire the first content corresponding to the content identifier after a preset time interval, and display the re-acquired first content. That is, after the preset time interval, the client performs a refresh operation automatically to acquire and display the updated first content. Specifically, if the re-acquired first content is exactly the same as the previously displayed first content, the client may give up displaying the re-acquired first content (but continue displaying the previously acquired first content), or may further display the re-acquired first content; if the re-acquired first content is different from the previously displayed first content, the client displays the re-acquired first content. In this way, the client performs a refresh operation automatically, and the user can still see the web page corresponding to the first content updated in real time, even if the user performs no operation on the web page corresponding to the first content for a long time, thereby avoiding the problem that the client can only re-acquire the content corresponding to the content identifier as triggered by a click operation of the user, reducing the delay in re-displaying (refreshing) the content on the client, and improving display efficiency of the client.

After step 104, the client may further re-acquire the second content corresponding to the content identifier after a preset time interval, and display the re-acquired second content. After the preset time interval, the client performs a refresh operation automatically to acquire and display the updated second content. Specifically, if the re-acquired second content is exactly the same as the previously displayed second content, the client may give up displaying the re-acquired second content (but continue displaying the previously acquired second content), or may further display the re-acquired second content; if the re-acquired second content is different from the previously displayed second content, the client displays the re-acquired second content. In this way, the client performs a refresh operation automatically, and the user can still see the web page corresponding to the second content updated in real time, even if the user performs no operation on the web page corresponding to the second content for a long time, thereby avoiding the problem that the client can only re-acquire the content corresponding to the content identifier as triggered by a click operation of the user, reducing the delay in re-displaying (refreshing) the content on the client, and improving display efficiency of the client.

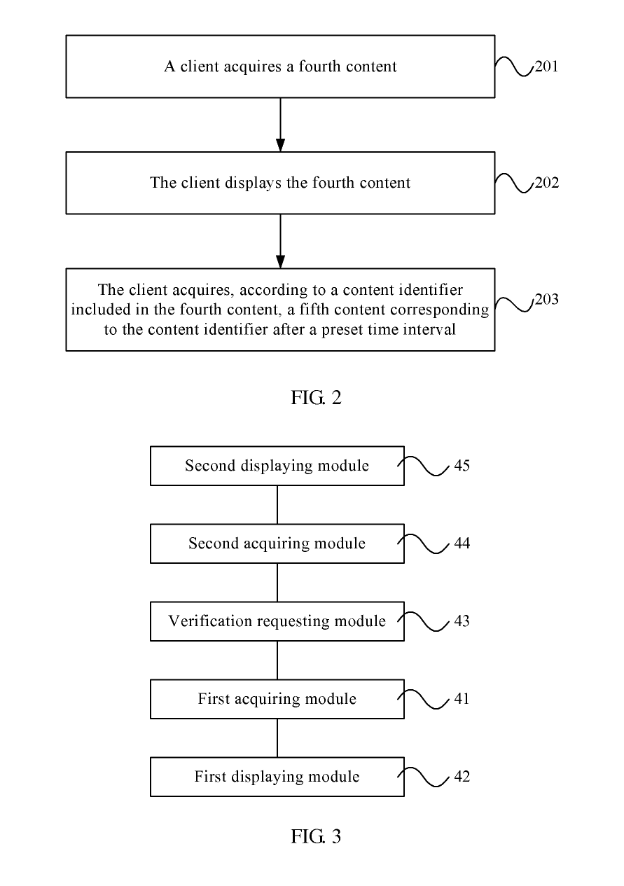

FIG. 2 is a schematic flowchart of another HTTP-based content acquisition method according to another embodiment of the present invention. As shown in FIG. 2, the HTTP-based content acquisition method in this embodiment may include the following steps:
Step 201: A client acquires a fourth content.
Step 202: The client displays the fourth content.
Step 203: The client acquires, according to a content identifier included in the fourth content, a fifth content corresponding to the content identifier after a preset time interval.

The fourth content may include multiple content identifiers, for example, a content identifier corresponding to a link label (such as a homepage link label, an entertainment link label, a real estate link label, and so on), a content identifier corresponding to a function control (such as a next-page function control (Next), a return function control (Back)), and so on.

In this way, if the client subsequently receives a command for displaying the fifth content as triggered by the user, the client may display the acquired fifth content directly.

Before this step, a step of acquiring, by the client, at least one content identifier included in the fourth content, may be included.

Optionally, the client may acquire, according to a function control in the fourth content, a content identifier corresponding to the function control, for example, a return function control (such as Back), and so on.

Optionally, the client may acquire, according to a link label in the fourth content, a content identifier corresponding to the link label, for example, a homepage link label, and so on.

In this embodiment, a client displays an acquired fourth content; after a preset time interval, the client may acquire, according to a content identifier included in the fourth content, a fifth content corresponding to the content identifier, thereby avoiding the problem that the client can only acquire the content corresponding to the content identifier according to the content identifier acquired as triggered by a click operation of the user, reducing the delay in displaying the content on the client, and improving display efficiency of the client.

It should be noted that, for brevity, the foregoing method embodiments are represented as a series of actions. However, persons skilled in the art should understand that the present invention is not limited to the order of the described actions, because according to the present invention, some steps may adopt other order or occur simultaneously. It should be further understood by persons skilled in the art that the described embodiments all belong to exemplary embodiments, and the involved actions and modules are not necessarily required by the present invention.

In the foregoing embodiments, the description of each of the embodiments has respective focuses. For a part that is not described in detail in a certain embodiment, reference may be made to related descriptions in other embodiments.

FIG. 3 is a schematic structural diagram of a client according to another embodiment of the present invention. As shown in FIG. 3, the client in this embodiment may include a first acquiring module 41, a first displaying module 42, a verification requesting module 43, a second acquiring module 44, and a second displaying module 45. The first acquiring module 41 is configured to acquire, according to an acquired content identifier, a first content corresponding to the content identifier and a validity period of the first content from a cache. The first displaying module 42 is configured to display the first content acquired by the first acquiring module 41. The verification requesting module 43 is configured to request, according to the validity period of the first content acquired by the first acquiring module 41, a server to verify validity of the first content. The second acquiring module 44 is configured to request to acquire a second content corresponding to the content identifier from the server if the validity verification performed by the server for the first content fails. The second displaying module 45 is configured to display the second content acquired by the second acquiring module 44.

The functions of the client in the embodiment corresponding to FIG. 1 may be implemented by the client provided in the embodiment of the present invention.

Optionally, the first acquiring module 41 in this embodiment may specifically acquire, according to the acquired content identifier, the first content corresponding to the content identifier and a validity period identifier of the first content from the cache, and acquire, according to the validity period identifier of the first content, a validity period corresponding to the validity period identifier of the first content.

Optionally, the first acquiring module 41 in this embodiment may further specifically acquire, according to the acquired content identifier, the first content corresponding to the content identifier from the cache, and use a preset validity period as the validity period of the first content.

Specifically, the verification requesting module 43 in this embodiment may specifically request the server to verify validity of the first content if the duration of caching the first content on the client exceeds the validity period.

Specifically, the first displaying module 42 in this embodiment may specifically display the first content according to characteristic information of the first content.

In this embodiment, a client acquires, through a first acquiring module according to an acquired content identifier, a first content corresponding to the content identifier and a validity period of the first content from a cache, and a first displaying module displays the first content. Meanwhile, according to the validity period of the first content, a verification requesting module requests a server to verify validity of the first content. If the validity verification performed by the server for the first content succeeds, the first displaying module may continue displaying the current first content, thereby avoiding the problem that the client does not display the content until the validity verification performed by the server for the content in the cache succeeds in the prior art, reducing the delay in displaying the content on the client, and improving display efficiency of the client.

Further, the first acquiring module 41 in this embodiment may further re-acquire the first content corresponding to the content identifier after a preset time interval. Correspondingly, the first displaying module 42 may further display the first content re-acquired by the first acquiring module 41. In this way, the client performs a refresh operation automatically, and the user can still see the web page corresponding to the first content updated in real time, even if the user performs no operation on the web page corresponding to the first content for a long time, thereby avoiding the problem that the client can only re-acquire the content corresponding to the content identifier as triggered by a click operation of the user, reducing the delay in re-displaying (refreshing) the content on the client, and improving display efficiency of the client.

Further, the second acquiring module 44 in this embodiment may further re-acquire a second content corresponding to the content identifier after a preset time interval. Correspondingly, the second displaying module 45 is further configured to display the second content re-acquired by the second acquiring module 44. In this way, the client performs a refresh operation automatically, and the user can still see the web page corresponding to the second content updated in real time, even if the user performs no operation on the web page corresponding to the second content for a long time, thereby avoiding the problem that the client can only re-acquire the content corresponding to the content identifier as triggered by a click operation of the user, reducing the delay in re-displaying (refreshing) the content on the client, and improving display efficiency of the client.

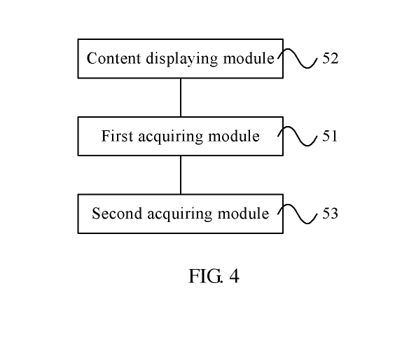

FIG. 4 is a schematic structural diagram of another client according to another embodiment of the present invention. As shown in FIG. 4, the client in this embodiment may include a first acquiring module 51, a content displaying module 52, and a second acquiring module 53. The first acquiring module 51 is configured to acquire a fourth content. The content displaying module 52 is configured to display the fourth content acquired by the first acquiring module 51. The second acquiring module 53 is configured to acquire, according to a content identifier included in the fourth content, a fifth content corresponding to the content identifier after a preset time interval.

The functions of the client in the embodiment corresponding to FIG. 2 may be implemented by the client provided in the embodiment of the present invention.

Further, the second acquiring module 53 in this embodiment may further acquire at least one content identifier included in the fourth content, which specifically includes: acquiring, according to a function control in the fourth content, a content identifier corresponding to the function control; or, acquiring, according to a link label in the fourth content, a content identifier corresponding to the link label.

In this embodiment, a client displays, through a content displaying module, a fourth content acquired by a first acquiring module; after a preset time interval, a second acquiring module may acquire, according to a content identifier included in the fourth content, a fifth content corresponding to the content identifier, thereby avoiding the problem that the client can only acquire the content corresponding to the content identifier according to the content identifier acquired as triggered by a click operation of the user, reducing the delay in displaying the content on the client, and improving display efficiency of the client.

Persons of ordinary skill in the art should understand that all or part of the steps of the methods in the embodiments may be implemented by a program instructing relevant hardware. The program may be stored in a computer readable storage medium. When the program is run, the steps of the methods in the embodiments are performed. The storage medium may be any medium capable of storing program codes, such as a ROM, a RAM, a magnetic disk, or an optical disk.

Finally, it should be noted that the foregoing embodiments are merely intended for describing the technical solutions of the present invention rather than limiting the present invention. Although the present invention is described in detail with reference to the foregoing embodiments, persons of ordinary skill in the art should understand that they may still make modifications to the technical solutions described in the foregoing embodiments or make equivalent replacements to some technical features in the technical solutions, as long as such modifications or replacements do not cause the essence of corresponding technical solutions to depart from the scope of the technical solutions of the embodiments of the present invention.

What is claimed is:

1. An HTTP-based content acquisition method, comprising:
acquiring, by a client according to an acquired content identifier, a first content corresponding to the content identifier and a validity period of the first content from a cache;
displaying, by the client, the first content;
requesting, by the client according to the validity period of the first content, a server to verify validity of the first content;
requesting, by the client, to acquire a second content corresponding to the content identifier from the server if the validity verification performed by the server for the first content fails; and
displaying, by the client, the second content.

2. The method according to claim 1, wherein:
the step of acquiring, by a client according to an acquired content identifier, a first content corresponding to the content identifier and a validity period of the first content from a cache, specifically comprises:
acquiring, by the client according to the acquired content identifier, the first content corresponding to the content identifier and a validity period identifier of the first content from the cache; and
acquiring, by the client according to the validity period identifier of the first content, a validity period corresponding to the validity period identifier of the first content.

3. The method according to claim 1, wherein:
the step of acquiring, by a client according to an acquired content identifier, a first content corresponding to the content identifier and a validity period of the first content from a cache, specifically comprises:
acquiring, by the client according to the acquired content identifier, the first content corresponding to the content identifier from the cache; and
using, by the client, a preset validity period as the validity period of the first content.

4. The method according to claim 1, wherein:
the step of requesting, by the client according to the validity period of the first content, a server to verify validity of the first content, specifically comprises:
requesting, by the client, the server to verify validity of the first content if a duration of caching the first content on the client exceeds the validity period.

5. The method according to claim 1, wherein:
the step of displaying, by the client, the first content, specifically comprises:
displaying, by the client, the first content according to characteristic information of the first content.

6. The method according to claim 1, wherein after the client displays the first content, the method further comprises:
re-acquiring, by the client, the first content corresponding to the content identifier after a preset time interval; and
displaying, by the client, the re-acquired first content.

7. The method according to claim 1, wherein after the client displays the second content, the method further comprises:
re-acquiring, by the client, the second content corresponding to the content identifier after a preset time interval; and
displaying, by the client, the re-acquired second content.

8. An HTTP-based content acquisition method, comprising:
acquiring, by a client, a fourth content;
displaying, by the client, the fourth content; and
acquiring, by the client according to a content identifier included in the fourth content, a fifth content corresponding to the content identifier.

9. The method according to claim 8, wherein:
the fourth content comprises at least one content identifier, and the step of acquiring, by the client, a content identifier included in the fourth content, specifically comprises:
acquiring, by the client according to a function control in the fourth content, a content identifier corresponding to the function control; or acquiring, by the client according to a link label in the fourth content, a content identifier corresponding to the link label.

10. A client comprising:
at least one processor and a memory coupled to the at least one processor;
wherein the at least one processor is configured to:
acquire, according to an acquired content identifier, a first content corresponding to the content identifier and a validity period of the first content from a cache;
display the first content;
request, according to the validity period of the first content, a server to verify validity of the first content;
request to acquire a second content corresponding to the content identifier from the server if the validity verification performed by the server for the first content fails; and
display the second content.

11. The client according to claim 10, wherein the acquire, according to an acquired content identifier, a first content corresponding to the content identifier and a validity period of the first content from a cache comprises:
acquire, according to the acquired content identifier, the first content corresponding to the content identifier and a validity period identifier of the first content from the cache; and
acquire, according to the validity period identifier of the first content, a validity period corresponding to the validity period identifier of the first content.

12. The client according to claim 10, wherein the acquire, according to an acquired content identifier, a first content corresponding to the content identifier and a validity period of the first content from a cache comprises:
acquire, according to the acquired content identifier, the first content corresponding to the content identifier from the cache; and
use a preset validity period as the validity period of the first content.

13. The client according to claim 10, wherein the request, according to the validity period of the first content, a server to verify validity of the first content comprises:
request the server to verify validity of the first content if a duration of caching the first content on the client exceeds the validity period.

14. The client according to claim 10, wherein the display the first content comprises:
display the first content according to characteristic information of the first content.

15. The client according to claim 10, wherein the at least one processor is further configured to:
after display the first content, re-acquire the first content corresponding to the content identifier after a preset time interval; and
display the re-acquired first content.

16. The client according to claim 10, wherein the at least one processor is further configured to:
after display the second content, re-acquire the second content corresponding to the content identifier after a preset time interval; and
display the re-acquired second content.

17. A client comprising:
at least one processor and a memory coupled to the at least one processor;
wherein the at least one processor is configured to:
acquire a fourth content;
display the fourth content; and
acquire, according to a content identifier included in the fourth content, a fifth content corresponding to the content identifier.

18. The client according to claim 17, wherein the fourth content comprises at least one content identifier, and wherein the at least one processor is further configured to acquire a content identifier included in the fourth content;
wherein the acquire a content identifier included in the fourth content comprises:
acquire, according to a function control in the fourth content, a content identifier corresponding to the function control; or
acquire, according to a link label in the fourth content, a content identifier corresponding to the link label.

19. The client according to claim 10, wherein the at least one processor is further configured to:
acquire a fourth content;
display the fourth content; and
acquire, according to a content identifier included in the fourth content, a fifth content corresponding to the content identifier.

20. The client according to claim 19, wherein the fourth content comprises at least one content identifier, and wherein the at least one processor is further configured to acquire a content identifier included in the fourth content;
wherein the acquire a content identifier included in the fourth content comprises:
acquire, according to a function control in the fourth content, a content identifier corresponding to the function control; or
acquire, according to a link label in the fourth content, a content identifier corresponding to the link label.
